(19) United States
(12) Patent Application Publication
(10) Pub. No.: US 2006/0213123 A1
(43) Pub. Date: Sep. 28, 2006

(54) Growing system and inactive growing medium, in particular for use in the growing system

(76) Inventors: Gert Larsen, Køge (DK); Christine Rysgaard, Hvedevaenget (DK)

Correspondence Address: Cooper & Dunham, 1185 Avenue of the Americas, New York, NY, 10036, US

(21) Appl. No.: 10/556,845

(22) PCT Filed: Apr. 1, 2004
(86) PCT No.: PCT/DK04/00227

§ 371 Date: Nov. 15, 2005

(30) Foreign Application Priority Data
May 15, 2003 (DK) PA200300741
May 15, 2003 (DK) BA200300143

(51) Int. Cl. A01G 31/00; A01G 9/02

(52) U.S. Cl. 47/65.8; 47/64

(57) ABSTRACT

In a horticultural growing system including a container comprising an inactive growing medium, the container is shaped as a sealed bag or box of a material capable of containing the inactive medium together with water while remaining dry on the outer surface, and allowing for absorption and subsequent draining of water. The inactive growing medium is in the form of a mixture of lava products and clay products in proportioned mutual ratios, said mixture including one or more constituents selected from among pumice stone, Perlite, clay materials, light clinker and lava, but is can also contain zeolites and/or vermiculite and other constituents. The growing system provides environmental and economically advantages in that it can be used for up to five years without having to change the medium. In this time period, it is possible to produce 300 kg of tomatoes in one box.

### TECHNICAL FIELD

The invention relates to a horticultural growing system including a container comprising pan inactive growing medium, said growing system being characterised in that the container is shaped as a sealed bag or box of a material capable of containing the inactive medium together with water while remaining dry on the outer surface, and allowing for absorption and subsequent draining of water.

Specifically, the invention relates to a growing system including a special growing container in the form of a bag or box, in particular for use together with a newly-developed inactive horticultural growing medium This growing medium is particularly suited for the production of vegetables, pot plants and cut flowers in a green-house. Different mixtures provide different growing properties so that the individual gardener can design his own growing medium adapted to the current demand.

By using the growing system according to the invention instead of conventional containers, such as pots, flats, cultivation channels, etc., the garden nurseries avoid the laborious work of filling up, disinfecting and changing the plant containers. The garden nursery is able to use the same cultivation channels and watering systems as previously used.

### BACKGROUND ART

A number of growing systems are known having various purposes and effect mechanisms:

DE publication No 40 16 824 discloses a block for growing plants which can be lowered in water containing nutrient salts, and which includes mixtures of lava products and clay products in proportioned mutual ratios.

DE publication No 40 17 334 discloses a plant substrate in the form of a base granulate of lava and pumice stone, optionally burned clay together with a water storing agent in the form of a copolymer and a substance reducing the rate of the water flow, and optionally in the form of mineral fibre.

DK patent No 173,999 discloses mixtures of a carrier, a binder and additives for use in germinating units, either separate or in form of seed or plant tapes where the binder can be one or more substances selected from among vermiculite, perlite, zeolite, cellulose materials and burned clay. Further the patent mentions that natural useful fingi or bacteria can be present in the mixtures.

DE publication No 32 13 695 discloses a plant substrate of lava with a suitable particle size for the hydroponic and semi-hydroponic retainment of plants at soil-less plant cultures.

GB patent application No 2268929 discloses a growing medium for hydroponic culture in form of an expanded porous granular material (such as perlite) together with about 10% vermiculite. The medium is impregnated with a concentrated nutrient solution, is easy to handle and can be used by the simple addition of water.

U.S. Pat. No. 6,016,628 relates to a growing bag to be positioned in an outer box, for instance a flower box. The bag, which can contain any growing medium, such as ordinary soil, is made from a semi-permeable plastic material allowing the water to penetrate from the outside to the inside, but not readily from the inside to the out-side.

EP patent application No 1 082 894 discloses a firm growing block for soil-less cultivation enclosed by a flexible waterproof sleeve. The plant, whose root is arranged in a cubic retainer, is positioned in the growing block through a removable opening in the sleeve.

U.S. pat. No. 4,209,945 discloses various flat boxes provided with openings, through which the growing plants can grow when the boxes are used for cultivation purposes. However, in principle, they can be used for many other purposes, for example as cat litter boxes. The boxes are primarily shaped so that they can be easily transported/carried in the hand.

AU patent application No. A-60536/94 discloses a horticultural bag for storing, growing and transporting plants: As it appears from the drawing, the bag is shaped as an ordinary carrier bag with handles. Moreover, DE publication No 27 40 651 discloses growing containers in various shapes (boxes, buckets or the like) for use in for instance garden nurseries. The containers are made from an air- and water-proof plastic material and are provided with a firm, plane bottom and carrying handles.

Finally, GB patent application No 2,390,288 discloses various types of portable growing containers of soft plastics, where the plant grows through an opening at the top, and where holes are provided for draining by means of a pencil or another sharp object. There is no mention (neither in this publication nor in any of the above publications) of any specific plastic materials considered to provide particularly advantageous properties.

### DISCLOSURE OF INVENTION

A. The Container

A number of conditions have to be met as to strength, durability, quality and specific physical properties of the material used for producing the containers in order to obtain the advantages desired. Thus, it is intended that the container forming part of the growing system according to the invention is capable of keeping the inactive growing medium enclosed together with water while remaining dry on the outer surface.

When the container is a sealed bag, this is preferably made from a specific type of polypropylene of infinitely long fibres with an exceptional ability to retain the moisture. This material is marketed under the name of Lutrasil® and is a strong fibre web with a very durable structure due to the layer-on-layer of fibres and the texture in the material. Lutrasil® allows water to be absorbed and subsequently drained, and the air change in the bag per se will be very frequent so that problems of overwatering are avoided. Lutrasil® is already well-known in connection with the cultivation of plants for protecting crops, and the material is also widely used within other fields, for instance in the motor industry. However, it is hitherto unknown to use Lutrasil® for the production of growing bags with can contain a growing medium.

The physical shape, i.e. the size and form, of a sealed bag capable of containing the above growing medium can naturally vary according to the individual need. However for many practical purposes, a volume of approximately 8 to 10 litres is advantageous, without, however, limiting the invention thereto.

An example of a sealed bag for use in the mentioned system is an embodiment shown in FIG. 1. This bag can for example have the following dimensions:

Height: 16 cm;

Length: 30 to 40 cm;

Width: 20cm,

providing the above advantageous volume of 8 to 10 litres, but the dimensions can be selected freely. The bag is made from Lutrasil® or a similar product, which, as mentioned, due to the special texture, has a very durable structure allowing absorption and subsequent draining of water.

When the container is a box, this is preferably made from a material known per se denoted as “corrugated plastics” from the company of Weilplast. The material has the same appearance as ordinary corrugated cardboard, but is made from a mixture of polypropylene (49%) and CaCO₃ (51%) and is water-repellent.

### BRIEF DESCRIPTION OF THE DRAWINGS

The invention is explained in detail below with reference to the drawings, in which

FIG. 1 is a growing system according to the invention, where the container is a bag made from Lutrasil® or a similar product, and

FIGS. 2 and 3 are embodiments of a growing system according to the invention, where the container is a box, preferably made from the material “corrugated plastics” as described in greater detail below.

### BEST MODE FOR CARRYING OUT THE INVENTION

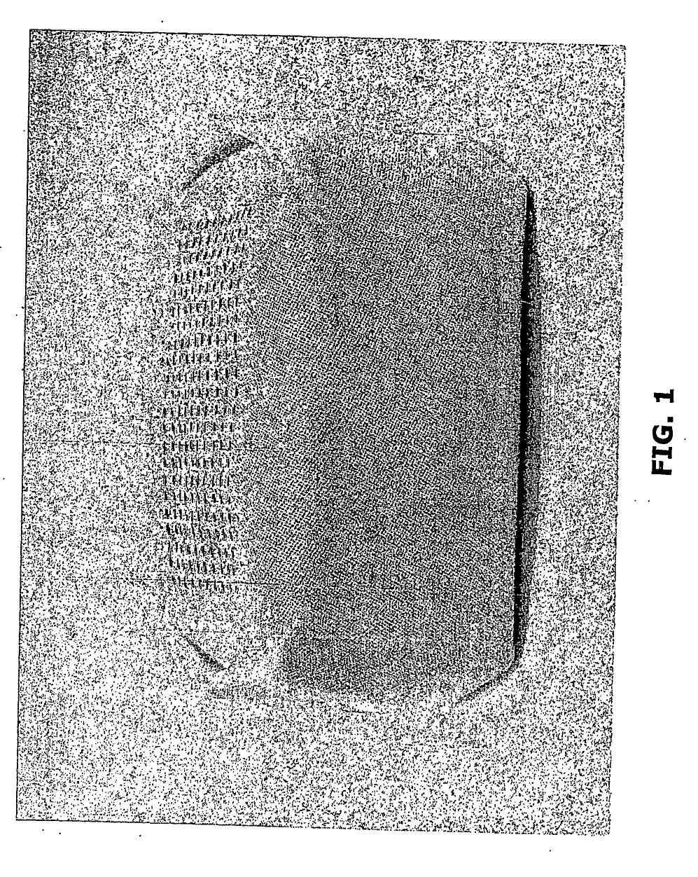

The bag shown in FIG. 1 is hand-sewn. However, it is of course also possible to produce the bag by welding. Moreover, the bag can be made “reversible” to allow cultivation on several surfaces of the bag over the years. The bag according to the invention is advantageous in that it is breathable and the air change is continuous during the entire growing period of the plant.

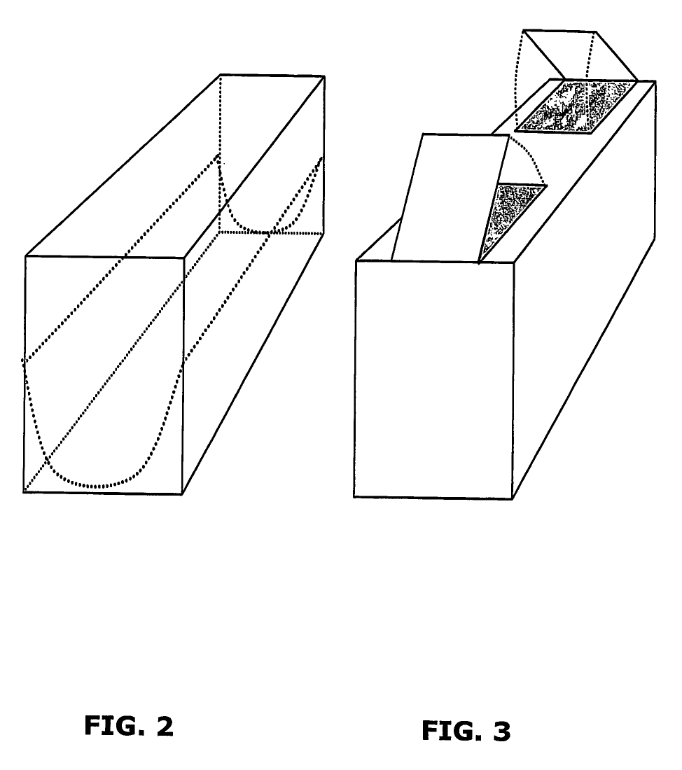

FIG. 2 shows a preferred embodiment of a box of corrugated plastics for use as a container in the growing system according to the invention. The bag is shaped in such as manner that it is adapted to the already existing systems at the garden nurseries. In order to increase the air supply to the plant root, the inner design differs from hitherto known designs. A “hammock” of Lutrasil® housing the growing medium can be provided in the interior of the box, thereby ensuring a frequent air change as well as allowing the plant root to breathe and release CO₂. Such a box typically contains 8 to 10 litres of growing medium and can for instance contain two tomato plants throughout the entire growing course. However, the box can be made without the hammock of Lutrasil® and can then contain a larger amount of the growing medium.

Cultivation may take place for five years in the above box without having to change the growing medium, which otherwise usually is done every year. As a result, both labour and materials are saved. During the period of five years, it is possible to grow more than 300 kg of tomatoes in one box. The used plant is cut off at the root when the growing process is completed, and the box is closed until a new culture is added.

When the culture is to begin, the box is re-opened and in order to avoid an excessive consumption of materials, the stake for the tomato or cucumber culture can be reused to secure the plant to the opening mechanism at the top of the box, cf. FIG. 3.

B. The Growing Medium

The invention also relates to a new horticultural inactive growing medium, said growing medium being in the form of a mixture of lava products and clay products in proportioned mutual ratios. The growing medium according to the invention is especially suited for the production of vegetables in a greenhouse. Different mixtures provide different growing properties so that the individual gardener can design his own growing medium adapted to the current demand.

Today, sphagnum is the most commonly used growing medium within the field of gardening. It is an active growing medium with many excellent properties and continues to be the preferred growing medium for pot plants. Sphagnum works well in a pot and provides good conditions for the plant with regard to water, air, nutrient conditions, and structural stability. In its capacity as an active growing medium, sphagnum contains organic material in a more or less converted state, which means that nutrients can be released and bound for the benefit of the plant. The nutrients are released as the organic materials decompose. Thus, the structure is not constant during the growing process but changes dependent on the progress of the decomposition processes. Thus, sphagnum has a tendency to collapse and change the air conditions during the growing period which effects that the optimum growing properties cannot be maintained for long periods of time, for example for several years. Another disadvantage of sphagnum is that in certain periods, often in very wet summers, the use of sphagnum involves partly inexplicable growing problems. Furthermore, when exporting to countries outside of Europe, it may be required that the growing medium is inactive. Finally, a further disadvantage of using sphagnum is that the breaking and digging up of sphagnum sometimes are considered to have a harmful effect on the raised bogs in the landscape.

Grodan is also a highly used and suitable growing medium, especially for use in the production of tomatoes and cucumbers. Grodan is an inactive growing medium, i.e. a medium which neither chemically binds nor releases nutrient ions or water, at least only to a very small degree. It is a volcanic material denoted diabes. Grodan was originally used as an insulation material, viz. mineral wool or “Rockwool”, but was subsequently found by coincidence to be suitable as a growing medium. Grodan, which has been marketed for almost 30 years, is either used in the pure form, as growing plates or in mixture with sphagnum, e.g. in connection with the production of pot plants, where a higher air content and increased stability in the growing medium are desired. Grodan has a poor buffer capacity in relation to the binding of water and the pH-stabilising ability as well as the conductivity are modest. Pure Grodan is therefore not suitable as a growing medium for pot plants and when using Grodan for growing vegetables in greenhouses, it is required that the garden nurseries are careful when dosing the water and fertilizer.

In connection with the production of pot plants, it is also known in certain cases to mix light clinker or Leca®, viz. light expanded clay aggregate, in sphagnum to increase the air content in the growing medium, Plants in pure Leca® are also used in connection with indoor planting in office environments and the like.

Other known inactive growing media are for example Perlite and pumice stone, which in the unmixed, i.e. pure, state is used to a less extent in the production of tomatoes and cucumbers. Perlite is also widely used to as a soil improving agent in active growing media, as the structure of the media thus is improved or sustained over a longer period of time.

In view of the dominant position of sphagnum and Grodan in connection with the gardening production, the above disadvantages thereof have given rise to a demand for the development of alternative growing media. Furthermore, since the known growing media separately only are suitable for growing certain plants or plant categories and growing systems, the applications of the media are limited in advance and it has thus been a distinct requirement of a new growing medium that the medium is capable of being composed in the optimum way, tailor-made so to speak, for the individual purpose in consideration of the very different needs of the individual plants and the technical arrangement of the garden nursery.

This is obtained by the new growing medium according to the invention, which is an inactive growing medium in the form of a mixture of lava products and clay products with different granulate sizes in proportioned mutual ratios. The growing medium according to the invention is characterised in that it includes one or more of the constituents selected from among pumice stone, Perlite, clay materials, light clinker and lava, optionally also including zeolites and/or vermiculite and optionally additional additives.

Specifically, the growing medium according to the invention includes:

from 0 to 90%, preferably from 0 to 50% of pumice stone;

from 0 to 90%, preferably from 0 to 50% of Perlite;

from 0 to 90%, preferably from 0 to 50% of light clinker;

from 0 to 1% of lava, and

from 0 to 10% of clay

and optionally from 1 to 10% of zeolites and/or from 1 to 50% of vermiculite and additional additives, preferably in a total amount of up to 1%.

The natural soil is a mixture of different inorganic or organic constituents which jointly provide unique growing properties. The composition of the soil varies greatly in various parts of the world, which—together with the varying climate conditions—is reflected in the diversity of plant types from the different areas. The purpose of the new growing medium according to the invention is to imitate the properties of the inorganic constituents of the soil, which means that the structure of the specific soil type is imitated in order to design an inactive growing medium for modern horticultural use. As mentioned above, the growing medium discussed is formed of a mixture of different lava products and clay products in proportioned ratios adjusted to the specific growing purpose. Different mixtures provide different growing properties.

The growing medium according to the invention contains a large amount of inorganic colloids, to which nutrients can be bound. The binding primarily occurs as a consequence of capillary forces from the hollow spaces or cavities, which are part of the structure of the different constituents. The structure of the surface and the electric potential can vary greatly in the various content substances. The total surface of 1 g of clay colloids is thus close to 700 m².

The surface of the colloids is covered by negative charges and a large amount or pore openings. This negatively charged porous surface binds positive nutrients from the surrounding water. Each content substance is capable of binding positive ions to an extent corresponding to the number of negative charges on the colloid surface. It is also possible to bind ions by capillary forces.

The positively charged ions are bound to the colloid surface exactly to such an extent that they are neither washed away nor washed off by repeated watering. The cations are however at the same time so loosely attached to the surface that they can be replaced by other cations added to the growing medium from the outside or added by changing the pH-value in the medium, viz. ion exchange.

The electric potential on the surface of the constituents of the growing medium is very versatile as each separate substance is structured so differently that the ability to absorb and release ions varies markedly. Thus, as a whole, the growing medium has varying ion exchange capacities. Each of the constituents; Perlite, light clinker and pumice stone has a grid of electric charges releasing and absorbing ions. As the granulate sizes vary, the electric surface charges in the media are also vary. This design has been developed to imitate the natural soil structure as much as possible.

The principle of the growing medium according to the invention is to design mixtures in exact accordance with the individual gardener's specific demands to his growing medium. It is possible to design the medium aimed at the cultivation needs of one specific culture.

For instance, the gardener can have the medium designed according to specific individual needs, such as the water binding, drainage, air content, buffer properties, pH-level and conductivity of the medium. Furthermore, it is possible in the medium to take into account which water system is used in the respective garden nursery and how the absorption of nutrient solution is desired.

In order to imitate the natural soil as much as possible, it would be an option to add micro-organisms from the natural soil to the medium, thereby inter alia improving the absorption of nutrient solution of the plant and its defence against pathogenic bacteria and fungi.

In other words, the object of developing the new growing medium is to provide the plant with the most optimum, natural health condition—as if the plant was arranged in a natural soil environment.

The most important constituents, including clay minerals and lava types, forming part of the growing medium according to the invention, are the following:

Perlite is a silicon-containing volcanic type of stone found in inter alia Greece and Turkey. In Denmark the raw material is prepared by grinding and subsequent heating, whereby the material expands 15 to 20 times and obtains its known airy granulate structure with a very large surface.

Expanded Perlite-granulates have water-absorbent properties and retain more and more water as the granulate structure is being reduced. At the same time, such granulates contain large pores providing good air properties.

Pumice stone is a volcanic type of stone found in several parts of the world, but for use as a growing medium, pumice stone from Iceland is often used. The pumice stone is washed thoroughly after the grinding and is granulated in different sizes which display different water-absorbent properties. The structure is an advantageous combination of small pores binding water and large pores providing air to the medium.

Light clinker or Leca® is produced from Danish plastic clay. After thorough pre-treatment, the clay is heated in rotary kilns to approx. 1100° C. at which temperature the clay expands to particles filled with air. Leca has slightly different properties than pumice stone and Perlite, as Leca also has a water-repellent property due to the hard surface of Leca as the material is burned at a higher temperature.

For many growing purposes, the medium according to the invention contains clay. Clay granulates from Sweden are preferably used in the form of mixtures of several different clay types. The clay granulate is produced by the upper layer of the soil surface being scraped off, after which the pure clay can be broken from the soil surface. After sun-drying, the clay is further processed by granulation. The clay is then heated to 80° C. and this light heating ensures a water content of only 3% in the finished product, which further does not contain nematodes, pathogenic virus, bacteria and any germinating seed weeds. The product is sorted according to the fineness thereof.

Since the clay is only heated slightly, it is possible to maintain the ability to bind the nutrient ions and subsequently release these ions for the absorption of nutrient solution of the plants. In other words, this type of clay can act as a buffer in the inactive medium.

As other colloids of clay minerals, the clay type from Sweden is layered in a crystal-like lattice. This lattice is formed alternately by silicon, oxygen and aluminiuim This lattice structure provides the negatively charged surface of the clay colloids. The layers of the clay colloids can be more or less fixed. In some types of clay colloids, the crystal lattice can be chained together less tightly. This means that some of the aluminium ions (Al³⁺) in the clay colloid can be replaced by for instance magnesium ions (Mg²⁺). As a result, free bindings occur in the crystal structure. This loose structure in the colloid provides an increased space between the layers of Si, O and now Mg²⁺ in the clay colloid, which in turn provides more space in the crystal lattice for small ions, for example potassium (K⁺).

Such clay colloids are not only able to bind nutrients on its outer surfaces, but also on an inner surface in the lattice structure. However, it is not all clay colloids which have the ability to loosen their own crystal lattice structure; this ability depends greatly on the type of clay used.

There are several types of clay. The clay used in the mixtures according to the invention includes a mixture of the types mentioned below:

| | Cation-capacity |
|---|---|
| Type of colloid | (milliequivalents/100 g) |
| Kaolinite | 3 to 15 |
| Illite | 10 to 40 |
| Montmorillonite | 80 to 120 |
| Vermiculite clay | 80 to 120 |
| Clay granulate from Sweden | 27.8 |
| Sepolite (clay product from Spain) | No values |

Sepolite excels by having an immense water-binding ability, more specifically up to 130 ml/100 g. Furthermore, the product has been approved for the production of food and animal feed.

It appears inter alia from the table which clay type has the loosest structure. The clay type montmorillonite is thus very loose and therefore has a high degree of nutrient binding. If the growing medium in question contains—or is added—large amounts of precisely this type of clay, a good nutrient binding is obtained, and moreover, this clay type has an exceptional ability to bind relatively large amounts of water.

In general, growing media containing extra clay provide more compact plants. By limiting the plant's access to easily accessible water, more compact plants are demonstrably obtained, but there is a thin limit between providing the plant with precisely the sufficient amount of water and desiccating it. The addition of clay to the growing medium according to the invention makes this desiccating limit much easier to control and the greenhouse gardener is thus provided with a new parameter as to the retardation of greenhouse cultures.

The different properties of the clay types can thus be exploited in many different ways in the medium according to the invention. In the clay granulate, a reasonable and effective mixture of the different clay types has already been made.

In the clay from Sweden, the mixture ratio is as follows:

| Type of clay mineral | Content (<0.02 mm) |
|---|---|
| Vermiculite clay | 46% |
| Illite | 44% |
| Kaolinite | 10% |

In total, this mixture thus provides a cation capacity of 27.8 mval/100 g.

The clay is a 100% natural material. The raw product is only divided into fine particles and screened for sorting, which means that there are no problems involved with returning it to nature after end use. By adding even small amounts thereof to the growing medium according to the invention, an obvious effect is obtained. Due to the cation capacity of the clay, it is now possible to obtain a buffer effect in an inactive medium in combination with increased water binding due to the swelling of the clay. When the clay swells, absorbs moisture and becomes wet, the state changes and the clay obtains a plastic surface. The chemical composition of the clay appears from the table below.

| Chemical reference | Content |
|---|---|
| SiO₂ | 66% |
| Al₂O₃ | 15.1% |
| Fe₂O₃ | 6.1% |
| CaO | 1.2% |
| MgO | 1.6% |
| K₂O | 3.6% |
| Na₂O | 1.0% |
| Mn₂O₃ | 0.1% |
| P₂O₅ | 0.1% |
| TiO₂ | 0.9% |

For the growing medium according to the invention, also pulverised volcanic lava material which contains large amounts of minerals can be used. Typical products, which are very applicable to the object of the invention, are Eifelgold and Pholin, both prepared from granulated lava. The two products are produced in Germany. When added to the growing medium according to the invention, the minerals are transformed into ion form so that they can be directly absorbed and exploited by the plants.

The two preferred lava products have the following compositions:

| Chemical reference | Eifelgold | Pholin |
|---|---|---|
| SiO₂ | 41% | 35% |
| Al₂O₃ | 14% | 11.5% |
| Fe₂O₃ | 12% | 10% |
| CaO | 16% | 13.6% |
| MgO | 8.5% | 20% |
| K₂O | 3% | 2.3% |
| P₂O₅ | 1% | 0.9% |
| Na₂O | 1.8% | |
| Mn₂O | Close to 0% | |
| TiO₂ | 3% | |
| Cu | | 49 ppm |
| Co | | 32 ppm |
| Ni | | 363 ppm |
| Mo | | 1.1 ppm |

All the chemical compounds in the above table are plant nutrients. By adding Eifelgold and/or Pholin to the growing medium according to the invention, it is possible to imitate the continuous disintegration process of minerals to nutrient ions which takes place in natural soil.

Zeolites belong to a large group of crystalline aluminium silicates suitable to be added to the growing medium due to their very quick and efficient absorption of the plant nutrients. The zeolites can then act as buffer in the growing medium. This means that using zeolites prevents the added nutrients from being washed off/leached. In the long run, the gardener can thus reduce his fertilizer consumption, as the inactive growing medium now contains a buffer and the added fertilizer is fully exploited.

Today, zeolites are used in greenhouses in biological filters for the purification of recirculated water. By adding zeolites to the growing medium according to the invention, it is possible to obtain a purifying effect on the return water which has an environmental effect.

In order to further improve and optimise the growing properties of the growing medium in question and to activate the medium biologically, it is possible to add nature's own useful fungi and bacteria.

As already mentioned, one of the objects of the invention is to provide growing media which can be provided with different growing properties as desired, so that the individual gardener can design his own growing medium which is carefully adjusted to the current demand, e.g. conditional on specific demands as to the watering system and the culture. The different constituents which can form part of the growing medium according to the invention provide abundant possibilities of composing a growing medium providing optimum growing and growth conditions for each culture.

Compared to Grodan, the new growing medium used according to the invention involves a significantly easier watering strategy for the individual gardener. It is an obvious advantage that it is impossible to over-water the growing medium and that it is possible to compose a growing medium where the desiccation limit can be determined. Furthermore, an important feature is that the growing medium can be used again and again and in the long run, is less expensive and better than the growing media available on the market.

As mentioned above, the growing medium according to the invention is especially suitable for the production of vegetables and pot plants in greenhouses, as for this purpose the medium has properties which in many respects are superior to the properties of the existing growing media. Thus, the medium may be used for several consecutive years, thereby allowing the garden nurseries producing vegetables in green-houses to avoid the vast annual costs involved in the purchase and handling of the growing medium at the beginning of a growing season.

Compared to the known growing media, the growing medium according to the invention has the following advantages:
The problems involved in cultivation in sphagnum due to wet summers are avoided;
The medium according to the invention does not collapse in the same way as sphagnum does at cultivation for long periods of more than one year; this feature may be relevant for garden nurseries and for companies offering indoor planting, and can also be an advantage in connection with cultivating as a hobby;
The possibilities of composing a specific optimum growing medium with regard to capillary forces, ion exchange, buffer effect, oxygen content etc. are increased when using the medium according to the invention than when using sphagnum, Grodan and other growing media.

The invention is illustrated in greater detail by the following example.

### EXAMPLE

Several tests have been carried out with different compositions of growing media according to the invention. For this purpose, the materials listed in Table 1 below have been used.

TABLE 1

| Material | Size | | Weight per litre | |
|---|---|---|---|---|
| Light clinker | 2 to 4 | mm | 394 | g |
| Perlite (medium) | 0 to 6 | mm | 113 | g |
| Perlite (fine) | 0 to 1.5 | mm | 67 | g |
| Clay (pulverised) | 0.1 to 2 | mm | 1455 | g |
| Clay (Sepolite) | 15 to 30 | mm | 590 to 690 | g |
| Pumice stone (granulate) | 2 to 8 | mm | 468 | g |
| Pumice stone (fine) | 0 to 1 | mm | 400 | g |
| Vermiculite (super fine) | 0.5 to 1.5 | mm | 146 | g |
| Vermiculite (fine) | 1 to 2 | mm | 136 | g |
| Vermiculite (medium) | 2 to 4 | mm | 108 | g |
| Pholin and Eifelgold | 0.00015 to 0.6 | mm | 1118 | g |

The materials used have the physical properties indicated in Table 2:

TABLE 2

| | Solid substance | | | Total |
|---|---|---|---|---|
| Material | per I. | Water per I. | Air per I. | (100 vol %) |
| Light clinker | 394 | 188 | 418 | 1000 |
| Perlite | 113 | 431 | 402 | 946 |
| (medium) | | | | |
| Perlite (fine) | 67 | 619 | 230 | 916 |
| Pumice stone | 468 | 218 | 404 | 1090 |
| (granulate) | | | | |
| Pumice stone | 400 | 622 | 182 | 1204 |
| (fine) | | | | |
| Vermiculite | 146 | 610 | 302 | 1058 |
| (super fine) | | | | |
| Vermiculite | 136 | 482 | 436 | 1054 |
| (fine) | | | | |
| Vermiculite | 108 | 326 | 564 | 998 |
| (medium) | | | | |

From the materials above, nine mixtures with varying conmpositions have been prepared. The nine mixtures shown in Table 3 below are intended to be as different as possible so that the basic growing needs are appropriately widely represented.

TABLE 3

| Mixture | | |
|---|---|---|
| No. | Content (portions) | Weight per litre |
| 1 | ⅓ of pumice stone (granulate), | 356 g |
| | ⅓ of Perlite (medium), | |
| | ⅓ of light clinker + clay | |
| 2 | ½ of pumice stone (granulate), | 488 g |
| | ½ of Perlite (medium) + clay | |
| 3 | ½ of light clinker, ½ of | 346 g |
| | Perlite (fine) + clay | |
| 4* | ½ of pumice stone (granulate), | 344 g |
| | ½ of Perlite (medium) + clay | |
| 5 | ⅓ of pumice stone (granulate), | 398 g |
| | ⅓ of Perlite (medium), | |
| | ⅓ of sphagnum (converted) | |
| 6 | ½ of Perlite (medium), | 522 g |
| | ½ of pumice stone | |
| | (granulate) + sphagnum | |
| 7 | ½ of sphagnum, ½ of | 616 g |
| | pumice stone (granulate) | |
| 8 | ½ of light clinker, ½ | 288 g |
| | of Perlite (medium) + | |
| | clay + Pholin | |
| 9 | ½ of Perlite (fine), ½ | 308 g |
| | of coconut | |

*This mixture is a used mixture in which tomatoes have been grown for 6 years.

Some of the mixtures are in the form of a fine granulate and have an ability to bind much water and a small amount of air. Other mixtures have the opposite effect—primarily to imitate the various needs of different cultures. With the above mixtures it is possible to obtain a weight less than the weight of pure pumice stone and pure Leca®. With the right packaging, the medium according to the invention is extraordinarily easy to handle and transport.

Mixture No. 9 is of a slightly different type than the others. This mixture is a very fine mixture with a relatively low air content, viz. 23%, and a high water content. This mixture is prepared for examining whether a growing medium according to the invention also is efficient in a small pot or in very fast cultures, such as cress and other herbs. An organic medium, i.e. coconut, has been added to the mixture.

When measuring the air and water capacity of the respective growing medium comparison is made with the known and used media, i.e. fine sphagnum (Pindstrup) and granulated Grodan (Greenmix). These comparison tests have been performed in order to evaluate the physical performance of the media according to the invention. The tests have been carried out by using standards from The Danish Institute of Plant and Soil Science, “Grøn viden” No. 51, May 1990. One litre pots are used from OS Plast 14 C (850109), injection-moulded with conventional universal drain and bed bottom. Weight: 24 g which has been deducted from all values depicted.

The pots of a height of 10 cm are filled up to the edge so that the growing medium is flush with the edge of the pot and is suitably compact, thereby preventing the medium from sinking during the measurements.

At the bottom of each pot, a coarse-meshed fibre web is arranged so as to keep the medium inside the pot, from which there still is free drain. The measurements are made by closing the draining holes at the bottom and filling up water to the edge. After ten minutes of free draining, the exuded water is weighed, and the air capacity is calculated. The results appear from Table 4.

TABLE 4

| Mixture | Exuded water | Air content |
|---|---|---|
| No. | (ml. per litre medium) | (vol. %) |
| 1 | 390 | 39% |
| 2 | 200 | 20% |
| 3 | 230 | 23% |
| 4 | 300 | 30% |
| 5 | 256 | 26% |
| 6 | 290 | 29% |
| 7 | 242 | 24% |
| 8 | 438 | 44% |
| 9 | 228 | 23% |
| Fine sphagnum | 260 | 26% |
| Grodan granulate | 306 | 31% |

A growing medium needs to have an air content of at least 20 vol. % to work properly. All the sampled mixtures according to the invention meet this criterion, as mixture No 1 and especially mixture No 8, which is without pumice stone, have high air content.

Under the same conditions as above, the dry weights of the media are measured in one litre pots, after which water is filled up to the edge of the pot. After ten minutes of free draining, the growing medium saturated with water is weighed.

The water content is measured in vol. % to provide a relevant impression of the ratio between solid substance, water and air in each pot. The results are listed in Table 5.

TABLE 5

| | Weight, dry | Weight, wet | Water content | |
|---|---|---|---|---|
| Mixture | (grams per | (grams per | in the medium, | Water con- |
| No. | litre) | litre) | gram | tent (vol %) |
| 1 | 356 | 612 | 256 | 26% |
| 2 | 488 | 780 | 292 | 30% |
| 3 | 346 | 696 | 350 | 38% |
| 4 | 344 | 702 | 358 | 36% |
| 5 | 398 | 766 | 368 | 36% |
| 6 | 522 | 824 | 302 | 27% |
| 7 | 616 | 946 | 330 | 28% |
| 8 | 288 | 514 | 226 | 24% |
| 9 | 308 | 746 | 437 | 40% |
| Fine | 394 | 846 | 452 | 38% |
| sphagnum | | | | |
| Grodan | 246 | 891 | 645 | 54% |
| granulate | | | | |

The calculated water content is not an expression of the water amount available to the plant during growth, as the water content includes water easily accessible, accessible and non-accessible to the plant.

It is clear that the finer the material used in the mixtures, the more water can be contained in the medium. This is especially obvious in mixture No. 3. This mixture is very fine, and each particle has a large surface with a widely spread pore structure where the diameter is very small. This provides a specifically high degree of water binding.

Stability of the Mixtures:

During the tests described above, observations have been made as to how the different mixtures react to large amounts of penetrating water. The mixtures are different and thus do not necessarily have the same stability.

It is clear that the finer the granulates, the easier it is for the mixtures to divide into layers when watering thoroughly.

The concluded stability of the mixtures during heavy watering is summarised in Table 6.

TABLE 6

| Mixture No | Stabiliy during heavy watering |
|---|---|
| 1 | Maintains the structure throughout all measurements. |
| 2 | Becomes layered during watering. Fine Perlite at |
| | the top of the pot |
| 3 | Becomes layered during watering. Fine Perlite at |
| | the top of the pot. Light collapse of the entire mixture. |
| 4 | Maintains the structure throughout all measurements. |
| 5 | Very weak layering during watering. Fine sphagnum |
| | at the top of the pot. |
| | Light collapse of the entire mixture. |
| 6 | Maintains the structure throughout all measurements |
| 7 | Maintains the structure, but light collapse when |
| | watering |
| 8 | Maintains the structure throughout all measurements |
| 9 | Maintains the structure throughout all measurements |

It is worth noticing that mixture No. 4, which is a 6-year-old mixture, maintains its structure throughout all tests. Purely objective experience show that the longer the medium is used, the more stable it becomes due to root penetration.

The roots simply maintain the structure and work continuously with the constituents of the medium.

1. A horticultural growing system comprising a container in the form of a sealed bag or a closed box containing an inactive growing medium, characterised in that (a) the container is made of a material capable of containing the inactive medium together with water while remaining dry on the outer surface, and allowing for absorption and subsequent draining of water, and (b) the interior of the box is provided with a suspended length of fibre web of polypropylene or the like material with re-closable openings through which the growing plant can pass, and to which openings the plant can be retained during growth.

2. A growing system according to claim 1, characterised in that the container is a sealed breathable bag and that the air change is continuous during the entire growing period of the plant.

3. A growing system according to claim 1, characterised in that the bag is made from a fibre web of polypropylene, or the like material.

4. A growing system according to claim 1, characterised in that the container is a sealed box made from a hydrophobic material and that the interior of the box is provided with a suspended length of fibre web of polypropylene or the like material with re-closable openings through which the growing plant can pass, and to which openings the plant can be retained during growth.

5. A growing system according to claim 1, characterised in that the container is a closed box made from a hydrophobic material and that the interior of the box is provided with a suspended length of fibre web of polypropylene or the like material with re-closable openings through which the growing plant can pass, and to which openings the plant can be retained during growth.

6. A growing system according to claim 4, characterised in that the fibre web is made of the material Lutrasil® or the like material.

7. A growing system according to claim 1, characterised in that the system includes an inactive growing medium in the form of a mixture of lava products and clay products in proportioned mutual ratios, said mixture including one or more constituents selected from among pumice stone, Perlite, clay materials, light clinker and lava.

8. A growing system according to claim 7, characterised in that the inactive growing medium includes from 0 to 90% of pumice stone, from 0 to 90% of Perlite, from 0 to 90% of light clinker, from 0 to 1% of lava and from 0 to 10% of clay as well as from 1 to 10% of zeolites and/or from 1 to 50% of vermniculite and additional additives.

9. A growing system according to claim 7, characterised in that it includes the clay material Sepolite.

10. A growing medium according to to claim 9, characterised in that it is selected from among media including:
½ pumice stone (granulate), ½ Perlite (medium), pholine, zeolites+clay;
⅓ pumice stone (granulate), 1/3 Perlite (medium), ⅓ light clinker+clay;
½ pumice stone (granulate), ⅓ Perlite (medium),+clay;
½ light clinker, ½ Perlite (medium)+clay;
½ light clinker, ½ Perlite (medium)+clay+Pholine;
½ Perlite (medium), ½ pumice stone (granulate)+sphagnum and
½ sphagnum, ½ pumice stone (granulate).

11. A growing system according to claim 3, wherein the bag is made of Lutrasile®.

12. A growing system according to claim 4, wherein the material is corrugated plastics comprising 51% of calcium carbonate and 49% of polypropylene.

13. A growing system according to claim 5, wherein the material comprises 100% propylene.

14. A growing system according to claim 7, wherein the mixture comprises zeolites and/or vermiculite.

15. A growing system according to claim 8, wherein the additional additives are in an additional amount of up to 1%.
